(19) United States
(12) Patent Application Publication
(10) Pub. No.: US 2022/0094829 A1
(43) Pub. Date: Mar. 24, 2022

(54) IMAGE FRAME PROCESSING FROM MULTIPLE IMAGE SENSORS

(71) Applicant: QUALCOMM Incorporated, San Diego, CA (US)

(72) Inventors: Jeyaprakash SOUNDRAPANDIAN, San Diego, CA (US); Lokesh Kumar Aakulu, Hyderabad (IN); Rohan Desai, San Diego, CA (US); Scott Cheng, Foothill Ranch, CA (US); Aravind Bhaskara, San Diego, CA (US)

(21) Appl. No.: 17/031,261

(22) Filed: Sep. 24, 2020

(51) Int. Cl. H04N 5/225; G06T 5/50; H04N 5/235

(52) U.S. Cl. CPC H04N 5/2258; H04N 5/2353; G06T 5/50

(57) ABSTRACT

Aspects relate to an image signal processor that processes frames from different image sensors. An example device includes a memory and an image signal processor coupled to the memory. The image signal processor is configured to provide a first trigger to a first image sensor (the first image sensor being coupled to the image signal processor), receive a first frame from the first image sensor at a first time in response to the first trigger being received by the first image sensor, process the first frame, provide a second trigger to the second image sensor (the second image sensor being coupled to the image signal processor), receive a second frame from the second image sensor at a second time in response to the second trigger being received by the second image sensor (with the second time subsequent to the first time), and process the second frame.

### TECHNICAL FIELD

This disclosure relates generally to image or video capture devices, including processing of image frames from multiple image sensors by an image signal processor.

### BACKGROUND

Many devices include multiple image sensors that may be used for capturing one or more image frames. For example, a smartphone or tablet includes multiple image sensors to be used in generating images or video for different imaging applications. A plurality of image signal processors, with each image signal processor coupled to a different image sensor, process the image frames from the multiple image sensors. The processed image frames may then be used for the imaging application (such as generating user photographs, recording video, performing augmented reality operations, and so on).

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Some aspects of the present disclosure relate to processing image frames from multiple image sensors by a single image signal processor. An example device includes a memory and an image signal processor coupled to the memory. The image signal processor is configured to provide a first trigger to a first image sensor (the first image sensor being coupled to the image signal processor), receive a first frame from the first image sensor at a first time in response to the first trigger being received by the first image sensor, process the first frame, provide a second trigger to the second image sensor (the second image sensor being coupled to the image signal processor), receive a second frame from the second image sensor at a second time in response to the second trigger being received by the second image sensor (with the second time subsequent to the first time), and process the second frame. The memory is configured to store the processed first frame and the processed second frame received from the image signal processor.

In some implementations, capture of the first frame by the first image sensor is based on when the first image sensor receives the first trigger, and capture of the second frame by the second image sensor is based on when the second image sensor receives the second trigger. The image signal processor may be configured to determine when to provide the second trigger to the second image sensor based on an imaging parameter associated with the first frame. The first image sensor begins capture of the first frame upon receiving the first trigger, and the second image sensor begins capture of the second frame upon receiving the second trigger. In some implementations, the imaging parameter includes one or more of an exposure window size for the first frame or a size of the first image sensor for readout for the first frame.

The second trigger may be associated with a blanking factor to delay readout of the second frame by the second image sensor to the image signal processor. In some implementations, the first frame and the second frame are captured concurrently, and the second frame is prevented from being received at the same time as the first frame at the image signal processor based on the delayed readout of the second frame by the second image sensor. The image signal processor may be configured to provide an indication of the blanking factor to the second image sensor, wherein the second image sensor applies the blanking factor to delay readout based on the indication.

In some implementations, the image signal processor is configured to provide the third trigger to the first image sensor, receive a third frame from the first image sensor at a third time in response to the third trigger being received by the first image sensor (with the third time subsequent to the first time and different than the second time), and process the third frame. The memory may be configured to store the processed third frame from the image signal processor. The image signal processor may also be configured to provide a fourth trigger to the second image sensor. A timing between the first trigger and the third trigger is associated with a first frame rate of the first image sensor, and a timing between the second trigger and the fourth trigger is associated with a second frame rate of the second image sensor different from the first frame rate. The image signal processor may also be configured to receive a fourth frame from the second image sensor at a fourth time in response to the fourth trigger being received by the second image sensor (with the fourth time subsequent to the second time and the fourth time) and process the fourth frame. The memory may be configured to store the processed fourth frame from the image signal processor.

In some implementations, the device includes one or more processors coupled to the memory, and the one or more processors are configured to obtain the processed first frame and the processed second frame from memory. The device may also include the first image sensor to capture the first frame and the second image sensor to capture the second frame. In some implementations, the device includes a display configured to display the processed first frame and the processed second frame.

An example method includes providing, by an image signal processor, a first trigger to a first image sensor (the first image sensor being coupled to the image signal processor), receiving, by the image signal processor, the first frame from the first image sensor at a first time in response to the first trigger being received by the first image sensor, processing the first frame, providing, by the image signal processor, a second trigger to a second image sensor (the second image sensor being coupled to the image signal processor), receiving, by the image signal processor, the second frame from the second image sensor at a second time in response to the second trigger being received by the second image sensor (with the second time subsequent to the first time), and processing the second frame.

In some implementations, capture of the first frame by the first image sensor is based on when the first image sensor receives the first trigger, and capture of the second frame by the second image sensor is based on when the second image sensor receives the second trigger. The method may include determining when to provide the second trigger to the second image sensor based on an imaging parameter associated with the first frame. The first image sensor begins capture of the first frame upon receiving the first trigger, and the second image sensor begins capture of the second frame upon receiving the second trigger. In some implementations, the imaging parameter includes one or more of an exposure window size for the first frame or a size of the first image sensor for readout for the first frame.

The second trigger may be associated with a blanking factor to delay readout of the second frame by the second image sensor to the image signal processor. In some implementations, the first frame and the second frame are captured concurrently, and the second frame is prevented from being received at the same time as the first frame at the image signal processor based on the delayed readout of the second frame by the second image sensor. The method may include providing, by the image signal processor, an indication of the blanking factor to the second image sensor, wherein the second image sensor applies the blanking factor to delay readout based on the indication.

In some implementations, the method includes providing, by the image signal processor, the third trigger to the first image sensor, receiving, by the image signal processor, a third frame from the first image sensor at a third time in response to the third trigger being received by the first image sensor (with the third time subsequent to the first time and different than the second time), and processing the third frame. The method may include providing, by the image signal processor, a fourth trigger to the second image sensor. A timing between the first trigger and the third trigger is associated with a first frame rate of the first image sensor, and a timing between the second trigger and the fourth trigger is associated with a second frame rate of the second image sensor different from the first frame rate. The method may also include receiving, by the image signal processor, a fourth frame from the second image sensor at a fourth time in response to the fourth trigger being received by the second image sensor (with the fourth time subsequent to the second time and the fourth time) and processing the fourth frame.

An example non-transitory, computer-readable medium stores instructions that, when executed by one or more processors of a device, cause the device to provide, by an image signal processor, a first trigger to a first image sensor (the first image sensor being coupled to the image signal processor), receive, by the image signal processor, the first frame from the first image sensor at a first time in response to the first trigger being received by the first image sensor, process the first frame, provide, by the image signal processor, a second trigger to a second image sensor (the second image sensor being coupled to the image signal processor), receive, by the image signal processor, the second frame from the second image sensor at a second time in response to the second trigger being received by the second image sensor (with the second time subsequent to the first time), and process the second frame.

In some implementations, capture of the first frame by the first image sensor is based on when the first image sensor receives the first trigger, and capture of the second frame by the second image sensor is based on when the second image sensor receives the second trigger. Execution of the instructions may also cause the device to determine when to provide the second trigger to the second image sensor based on an imaging parameter associated with the first frame. The first image sensor begins capture of the first frame upon receiving the first trigger, and the second image sensor begins capture of the second frame upon receiving the second trigger. In some implementations, the imaging parameter includes one or more of an exposure window size for the first frame or a size of the first image sensor for readout for the first frame.

The second trigger may be associated with a blanking factor to delay readout of the second frame by the second image sensor to the image signal processor. In some implementations, the first frame and the second frame are captured concurrently, and the second frame is prevented from being received at the same time as the first frame at the image signal processor based on the delayed readout of the second frame by the second image sensor. Execution of the instructions may also cause the device to provide, by the image signal processor, an indication of the blanking factor to the second image sensor, wherein the second image sensor applies the blanking factor to delay readout based on the indication.

In some implementations, execution of the instructions causes the device to provide, by the image signal processor, the third trigger to the first image sensor, receive, by the image signal processor, a third frame from the first image sensor at a third time in response to the third trigger being received by the first image sensor (with the third time subsequent to the first time and different than the second time), and process the third frame. Execution of the instructions may cause the device to provide, by the image signal processor, a fourth trigger to the second image sensor. A timing between the first trigger and the third trigger is associated with a first frame rate of the first image sensor, and a timing between the second trigger and the fourth trigger is associated with a second frame rate of the second image sensor different from the first frame rate. Execution of the instructions may also cause the device to receive, by the image signal processor, a fourth frame from the second image sensor at a fourth time in response to the fourth trigger being received by the second image sensor (with the fourth time subsequent to the second time and the fourth time) and process the fourth frame.

Another example device for image signal processing includes means for providing, by an image signal processor, a first trigger to a first image sensor (the first image sensor being coupled to the image signal processor), means for receiving, by the image signal processor, the first frame from the first image sensor at a first time in response to the first trigger being received by the first image sensor, means for processing the first frame, means for providing, by the image signal processor, a second trigger to a second image sensor (the second image sensor being coupled to the image signal processor), means for receiving, by the image signal processor, the second frame from the second image sensor at a second time in response to the second trigger being received by the second image sensor (with the second time subsequent to the first time), and means for processing the second frame.

In some implementations, capture of the first frame by the first image sensor is based on when the first image sensor receives the first trigger, and capture of the second frame by the second image sensor is based on when the second image sensor receives the second trigger. The device may include means for determining when to provide the second trigger to the second image sensor based on an imaging parameter associated with the first frame. The first image sensor begins capture of the first frame upon receiving the first trigger, and the second image sensor begins capture of the second frame upon receiving the second trigger. In some implementations, the imaging parameter includes one or more of an exposure window size for the first frame or a size of the first image sensor for readout for the first frame.

The second trigger may be associated with a blanking factor to delay readout of the second frame by the second image sensor to the image signal processor. In some implementations, the first frame and the second frame are captured concurrently, and the second frame is prevented from being received at the same time as the first frame at the image signal processor based on the delayed readout of the second frame by the second image sensor. The device may include means for providing, by the image signal processor, an indication of the blanking factor to the second image sensor, wherein the second image sensor applies the blanking factor to delay readout based on the indication.

In some implementations, the device includes means for providing, by the image signal processor, the third trigger to the first image sensor, means for receiving, by the image signal processor, a third frame from the first image sensor at a third time in response to the third trigger being received by the first image sensor (with the third time subsequent to the first time and different than the second time), and means for processing the third frame. The device may include means for providing, by the image signal processor, a fourth trigger to the second image sensor. A timing between the first trigger and the third trigger is associated with a first frame rate of the first image sensor, and a timing between the second trigger and the fourth trigger is associated with a second frame rate of the second image sensor different from the first frame rate. The device may also include means for receiving, by the image signal processor, a fourth frame from the second image sensor at a fourth time in response to the fourth trigger being received by the second image sensor (with the fourth time subsequent to the second time and the fourth time) and means for processing the fourth frame.

### BRIEF DESCRIPTION OF THE DRAWINGS

Aspects of the present disclosure are illustrated by way of example, and not by way of limitation, in the figures of the accompanying drawings and in which like reference numerals refer to similar elements.

FIG. 1 is a block diagram of a system to coordinate image frames from multiple image sensors for processing by an image signal processor.

FIG. 2 is a timing diagram for the system in FIG. 1 of coordinating the image frames from multiple image sensors for processing by the image signal processor.

FIG. 3 is a block diagram of an example device including an image signal processor for processing image frames from multiple image sensors.

FIG. 4 is a block diagram of an arrangement of multiple image sensors coupled to an image signal processor.

FIG. 5 is an illustrative flow chart depicting an example operation for coordinating processing of image frames from multiple image sensors by a single image signal processor.

FIG. 6 is a timing diagram of timing triggers for multiple image sensors coupled to a single image signal processor.

FIG. 7 is a timing diagram of frame readouts from multiple image sensors to a single image signal processor based on blanking.

### DETAILED DESCRIPTION

Aspects of the present disclosure may be used for image capture and processing devices including or coupled to multiple image sensors. Some aspects include processing image frames from the multiple image sensors by a single image signal processor.

Many devices include multiple image sensors, and the image sensors may capture frames during a same time period. For example, a smartphone may include a configuration of three cameras or a configuration of two cameras on a backside of the device, and the configuration of cameras may be used to capture image frames for a bokeh effect in images, a portrait mode for imaging, stereoscopic imaging, or other applications utilizing multiple image sensors. In another example, all of the image sensors of the configuration may be initialized to readout frames concurrently. Devices with multiple image sensors include one or more image signal processors to process the images provided by the image sensors. The one or more image signal processors provide the processed image frames to a memory, and an application processor may access the memory to obtain the processed image frames for further processing (such as for encoding or other manipulation).

As used herein, an image sensor may refer to the image sensor itself and any other suitable components coupled to the image sensor. For example, an image sensor may also refer to other components of a camera, including a shutter, buffer, or other readout circuitry. The image sensor may further refer to an analog front end or other circuitry for converting analog signals to digital representations for the frame. Therefore, the term “image sensor” herein may refer to any suitable components for capture and readout of an image frame to an image signal processor.

If a device includes a dedicated image signal processor for each image sensor and the number of image sensors increases per device, the additional image signal processors require additional space, and operation of the additional image signal processors require additional power resources. The device may thus include fewer image signal processors than image sensors. In this manner, one image signal processor processes frames from two or more image sensors. However, an image signal processor is configured to receive one image frame and begin processing the image frame before receiving the next image frame. If multiple image sensors are coupled to the same image signal processor, frame data from the multiple image sensors may be provided to the image signal processor at the same time. For example, two image sensors may perform a readout of frames at the same time, and the data read out from the image sensors are thus provided to the image signal processor at the same time (even though the image signal processor is only able to receive one frame at a time for processing).

For many devices, one of the image sensors is a master and the other image sensors are slaves to the master image sensor. The master image sensor may synchronize frame captures (such as a start of exposure (SoE) or start of frame (SoF)) among the image sensors via a synchronization signal provided to each of the image sensors, and the image sensors may readout frame data to an image signal processor concurrently as a result of the synchronized frame captures. To prevent frame data from different image sensors being received at the same time by an image signal processor, a device may include coordination circuitry to receive the frames from the different image sensors that are read out concurrently and then provide the frames sequentially to an image signal processor.

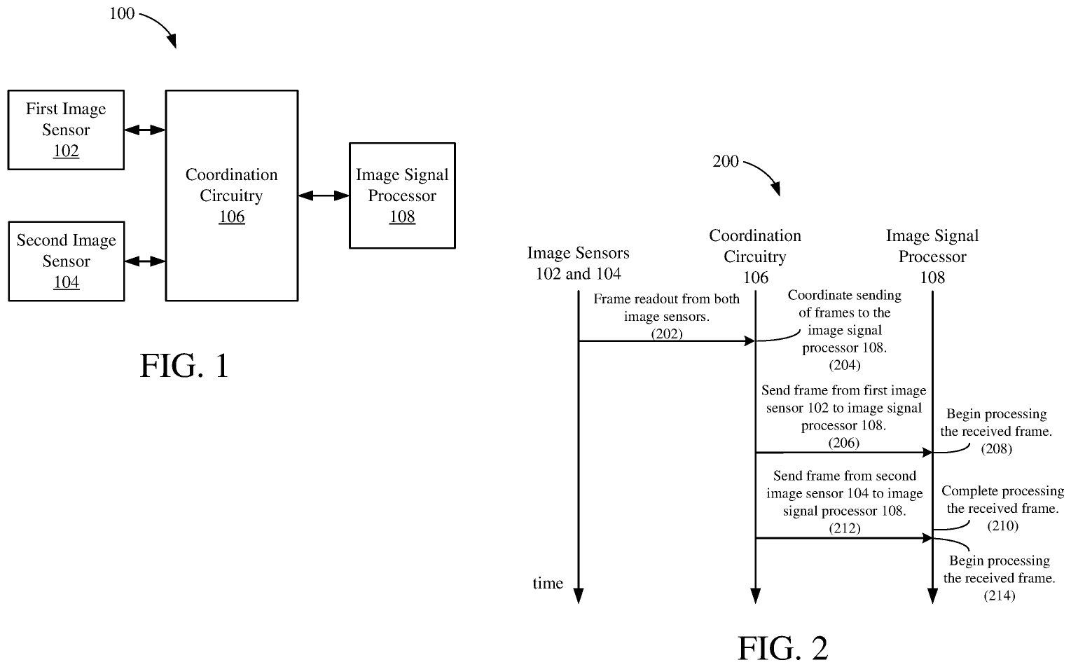

FIG. 1 is a block diagram of a system 100 to coordinate image frames from image sensors 102 and 104 for processing by an image signal processor 108. The system 100 includes a coordination circuitry 106 to receive frames from the first image sensor 102 and the second image sensor 104 and coordinate providing the frames sequentially to the image signal processor 108 for processing. The coordination circuitry 106 prevents the image signal processor 108 from receiving frame data from the different image sensors 102 and 104 at the same time, and the image signal processor 108 is able to process the frames in the order received.

FIG. 2 is a timing diagram 200 for the system 100 in FIG. 1 of coordinating the image frames from multiple image sensors 102 and 104 for processing by the image signal processor 108. In the example, the first image sensor 102 may be a master, and the second image sensor 104 may be a slave to the first image sensor 102. In this manner, the first image sensor 102 may synchronize frame capture between the image sensors 102 and 104, and at least a portion of readouts of the frames from the image sensors 102 and 104 may overlap. In this manner, a frame readout from both image sensors 102 and 104 occurs at time 202. As used herein, a frame readout or receiving a frame may refer to a portion of the frame being readout or received (such as one or more lines of the frames). For example, one or more lines of a frame from the first image sensor 102 may be output, then one or more lines of a frame from the second image sensor 104 may be output, and then one or more additional lines of the frame from the first image sensor 102 may be output towards the coordination circuitry 106. As a result, an entire frame from one of the image sensors is not received before a different frame from the other image sensor begins to be received.

At time 204, the coordination circuitry 106 coordinates sending the frames received from the image sensors 102 and 104 to the image signal processor 108 for processing. The coordination is in response to receiving the frames from the image sensors (202). The coordination circuitry 106 may include a first buffer or other storage element to temporarily store frame data from the first image sensor 102, and the coordination circuitry 106 may include a second buffer or other storage element to temporarily store from data from the second image sensor 104. The coordination circuitry 106 also includes logic to determine the order in which to provide the frames to the image signal processor 108, when to provide each frame to the image signal processor 108, and other operations to prevent any portion of the frames from the different image sensors from being provided to the image signal processor 108 concurrently. The circuitry 106 may also include one or more switches and decision logic to determine which buffer is to receive the current incoming frame data from an image sensor.

At time 206, the coordination circuitry 106 sends the frame from the first image sensor 102 to the image signal processor 108. The coordination circuitry 106 also prevents the frame from the second image sensor 104 from being sent to the image signal processor 108 at time 206. The image signal processor 108 receives the frame captured by the first image sensor 102 and begins processing the frame at time 208. The coordination circuitry 106 completes sending the frame to the image signal processor 108 before beginning to send the next frame to the image signal processor. In this manner, the frame captured by the second image sensor 104 is not sent to the image signal processor 108 before sending the previous image frame to the image signal processor 108 is completed. The coordination circuitry 106 may also delay sending the frame captured by the second image sensors 104 until the image signal processor 108 completes processing the previous frame (such as illustrated in FIG. 2, with the image signal processor completing processing of the frame at time 210). In delaying the frame from the second image sensor 104 being provided to the image signal processor 108, the coordination circuitry 106 may determine when the image signal processor 108 completes processing (such as when the processed image frame is sent to memory by the image signal processor 108, using an amount of time sufficient to ensure completion of frame processing, and so on).

With the frame from the first image sensor 102 being completely sent to the image signal processor 108 (and the image signal processor 108 completing processing of the frame), the coordination circuitry 106 sends the frame captured by the second image sensor 104 to the image signal processor 108 at time 212. The image signal processor 108 begins processing the received frame at time 214, and the next frame is delayed from being sent by the coordination circuitry 106 to the image signal processor 108 at this time. Such a process may continue for any number of frames to be processed, and the coordination circuitry 106 may be expanded to receive frames from additional image sensors.

A problem with the inclusion of coordination circuitry between the image signal processor and the multiple image sensors is the space requirements for the coordination circuitry. For example, the circuitry requires a plurality of logic, buffers, and other integrated circuits to perform the coordination. In addition, as the number of image sensors to be coupled to a single image signal processor increases, the space requirements for the coordination circuitry exponentially increases. Furthermore, the coordination circuitry is always on during operation of the image sensors and thus requires power resources to operate.

Another problem with coordination circuitry is that a delay between readout and processing of frames may exist. For example, if two image sensors concurrently readout frames to the same image signal processor, only one of the frames can be processed when received by the image signal processor, and the other frame is delayed in being processed. The coordination circuitry may also introduce an inherent latency caused by the frames passing through one or more components (such as a buffer) associated with a latency for data passing through the component. Such delays may be too large for some imaging applications, especially for image sensors operating at a high frame rate. High frame rate (HFR) video and other HFR imaging applications (including near real time depth enhancement or other applications) may not be performed as a result of the latencies, or the latencies may cause a significant lag in video, depth enhancement, or other imaging applications to negatively impact the user experience.

A further problem with coordination circuitry (and with one of the image sensors being a master to the other image sensors) is that the image sensors are required to operate at a static frame rate. In one example, if a video's frame rate is to be adjusted during capture, the image sensor requires its frame rate to be adjusted. Adjusting the frame rate requires a pause in operation of the image sensor, which causes a pause or gap in the video.

In some implementations, an image signal processor is configured to coordinate the reception of frames from multiple image sensors coupled to the image signal processor. In this manner, frames are received sequentially by the image signal processor even if frames are captured concurrently by the image sensors. To coordinate the reception of frames, the image signal processor coordinates the readout of the frames by the image sensors to the image signal processor. Coordinating frame readout may be performed by triggering frame capture (such as a SoE) or delaying readout of a frame to ensure frames are received sequentially at the image signal processor. In this manner, the image signal processor does not require coordination circuitry or other logic at the front end of the image signal processor to coordinate providing image frames sequentially that would otherwise be received concurrently (since image frames are ensured to be received in a sequential manner). Furthermore, coordinating the readout of frames allows for reducing or removing a delay between receiving a frame and processing the frame.

The image sensors may all be slaves to the image signal processor (instead of being slaves to one of the image sensors). The image signal processor may provide a trigger to each image sensor to indicate when to capture (or readout) an image frame. In this manner, the image signal processor also controls if and when an image sensor is to capture an image frame. As a result, in addition to coordinating readout of the image frames so that they are received sequentially by the image signal processor, a device's power consumption may be reduced when frame capture is not required by an application, as the image signal processor may not provide a trigger to one or more image sensors during such time (and the image sensors do not consume power capturing and reading out image frames when not needed). The time to reconfigure an image sensor may also be reduced based on the image sensor being a slave to the image signal processor.

Another benefit is that gaps in video or delays in an imaging application associated with a frame rate change may be reduced or removed. For example, if an image sensor's frame capture is based on triggers provided by the image signal processor, a frame rate adjustment may be controlled by the image signal processor by adjusting the timing between triggers. In this manner, an image sensor's frame rate may be increased by reducing the time between triggers, and an image sensor's frame rate may be decreased by increasing the time between triggers (without requiring disabling the image sensor to change the frame rate). Other benefits of the present disclosure may also become evident in the provided examples and description herein.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure. Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any suitable electronic device including or coupled to two or more image sensors capable of capturing image frames (also referred to as frames) for video (such as security systems, smartphones, tablets, laptop computers, digital video cameras, and so on). Further, aspects of the present disclosure may be implemented in devices having or coupled to image sensors of the same or different capabilities and characteristics (such as resolution, shutter speed, sensor type, and so on).

The terms “device” and “apparatus” are not limited to one or a specific number of physical objects (such as one smartphone, one camera controller, one processing system and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

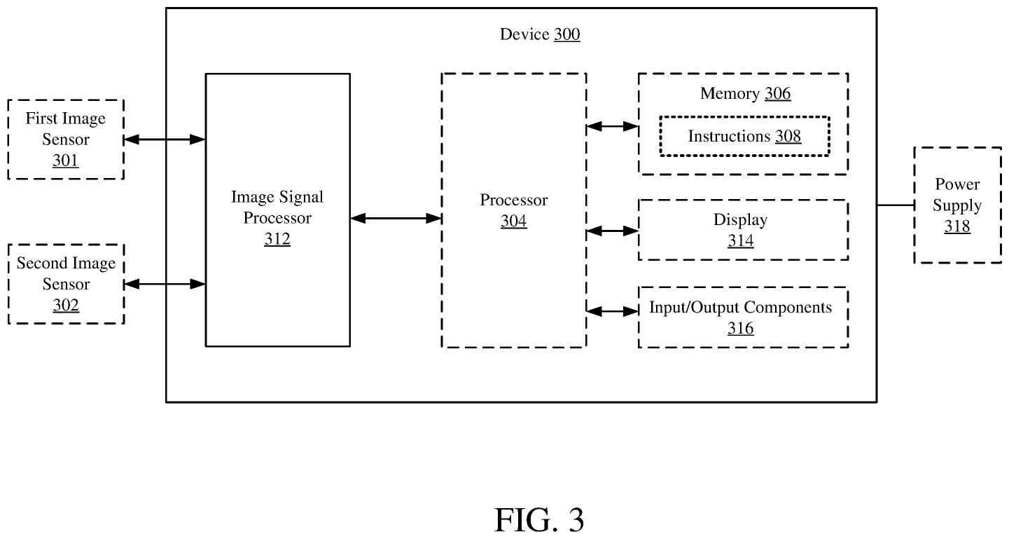

FIG. 3 is a block diagram of an example device 300 including an image signal processor 312 for processing image frames from multiple image sensors (including image sensors 301 and 302). In some implementations, the example device 300 also includes or is coupled to a processor 304 and a memory 306 storing instructions 308. The device 300 may further include a first image sensor 301 and a second image sensor 302. In some other implementations, the device 300 is coupled to the first and second image sensors separate from the device 300. The device 300 may also include or be coupled to a display 314 and a number of input/output (I/O) components 316. The device 300 may further include or be coupled to a power supply 318 for the device 300 (such as a battery or a component to couple the device 300 to an energy source). The device 300 may include or be coupled to additional features or components not shown. In one example, a wireless interface, which may include a number of transceivers and a baseband processor, may be included for a wireless communication device. In another example, one or more sensors (such as a gyroscope or a global positioning system (GPS) receiver) may be included in or coupled to the device. In a further example, an analog front end to convert analog image frame data to digital image frame data may be coupled between the one or more image sensors 301 and 302 and the image signal processor 312.

The first image sensor 301 and the second image sensor 302 are configured to capture one or more image frames. For example, the first image sensor 301 and the second image sensor 302 may be included in one multiple camera configuration or in separate single cameras or separate multiple camera configurations (such as a dual camera configuration, a triple camera configuration, and so on for a smartphone or other suitable device). The image sensors 301 and 302 may also include or be coupled to one or more lenses for focusing light, one or more apertures for receiving light, one or more shutters for blocking light when outside an exposure window, one or more color filter arrays (CFAs) for filtering light outside of specific frequency ranges, one or more analog front ends for converting analog measurements to digital information, or other suitable components for imaging. The device 300 may also include a flash, a depth sensor, a GPS, or other suitable components for imaging.

The image sensors 301 and 302 may be configured to be a slave to the image signal processor 312 (with neither image sensor nor any other image sensor coupled to the image signal processor 312 being a master to the image sensors 301 and 302). In this manner, instead of the image sensors 301 and 302 coupled to one another or any other image sensor for a master slave relationship between image sensors, the image sensors 301 and 302 are coupled to the image signal processor 312 for such relationship. With the image sensors 301 and 302 as slaves of the image signal processor 312, the image sensors 301 and 302 are configured to wait for a trigger from the image signal processor 312 to begin image frame capture or readout of the image frame. For example, a trigger provided from the image signal processor 312 to one of the image sensors 301 or 302 may cause the image sensor to begin a SoE for image frame capture. The image sensors 301 and 302 may also be configured to read out their respective image frames to the image signal processor 312.

The image signal processor 312 is a single image signal processor 312 to process captured image frames provided by the image sensors 301 and 302. The image signal processor 312 may also be configured to provide the triggers to the image sensors 301 and 302 to control capture or readout of the image frames from the image sensors 301 and 302. In this manner, the device 300 is able to control the image sensors 301 and 302 to readout image frames sequentially to the image signal processor 312 (and thus not require coordination circuitry between the image signal processor 312 and the image sensors 301 and 302).

While FIG. 3 illustrates the example device 300 as including two image sensors 301 and 302 coupled to the image signal processor 312, any number of image sensors may be coupled to the image signal processor 312. In addition, any number of additional image sensors or image signal processors may exist for the device 300 as long as at least two image sensors are coupled to a single image signal processor for processing frames from the two image sensors.

In some aspects, the image signal processor 312 may execute instructions from a memory (such as instructions 308 from the memory 306, instructions stored in a separate memory coupled to or included in the image signal processor 312, or instructions provided by the processor 304. In addition or alternative to the image signal processor 312 configured to execute software, the image signal processor 312 may include specific hardware (such as one or more integrated circuits (ICs)) to perform one or more operations described in the present disclosure.

In some implementations, the device 300 includes a memory 306. The memory 306 may include a non-transient or non-transitory computer readable medium storing computer-executable instructions 308 to perform all or a portion of one or more operations described in this disclosure. In some implementations, the instructions 308 include a camera application (or other suitable application) to be executed by the device 300 for generating images or videos. The instructions 308 may also include other applications or programs executed by the device 300 (such as an operating system and specific applications other than for image or video generation). Execution of the camera application (such as by the processor 304) may cause the device 300 to generate images using the image sensors 301 or 302 and the image signal processor 312. The memory 306 may also be accessed by the image signal processor 312 to store processed frames or may be accessed by the processor 304 to obtain the processed frames. In some other implementations, the device 300 does not include the memory 306. For example, the device 300 may be a circuit including the image signal processor 312, and the memory is outside the device 300. The device 300 may be coupled to the memory and configured to access the memory for writing processed frames.

In some implementations, the device 300 includes a processor 304. The processor 304 may include one or more general purpose processors capable of executing scripts or instructions of one or more software programs (such as instructions 308) stored within the memory 306. For example, the processor 304 may include one or more application processors configured to execute the camera application (or other suitable application for generating images or video) stored in the memory 306. In executing the camera application, the processor 304 may be configured to instruct the image signal processor 312 to perform one or more operations with reference to the image sensors 301 or 302. Execution of instructions 308 outside of the camera application by the processor 304 may also cause the device 300 to perform any number of functions or operations. In some implementations, the processor 304 may include ICs or other hardware in addition to the ability to execute software to cause the device 300 to perform a number of functions or operations (including the operations described herein). In some other implementations, the device 300 does not include the processor 304. For example, if the device 300 is a circuit including the image signal processor 312, the device 300 may be coupled to a processor for performing one or more of the described operations.

In some implementations, the device 300 includes a display 314. The display 314 may include one or more suitable displays or screens allowing for user interaction and/or to present items to the user (such as a preview of the image frames being captured by the image sensors 301 and 302). In some aspects, the display 314 is a touch-sensitive display. The device 300 may also include I/O components 316, and the I/O components 316 may be or include any suitable mechanism, interface, or device to receive input (such as commands) from the user and to provide output to the user. For example, the I/O components 316 may include (but are not limited to) a graphical user interface (GUI), keyboard, mouse, microphone and speakers, a squeezable bezel, one or more buttons (such as a power button), a slider or switch, and so on.

While shown to be coupled to each other via the processor 304 in the example of FIG. 3, the processor 304, the memory 306, the image signal processor 312, the display 314, and the I/O components 316 may be coupled to one another in various arrangements. For example, the processor 304, the memory 306, the image signal processor 312, the display 314, and/or the I/O components 316 may be coupled to each other via one or more local buses (not shown for simplicity). In another example, while the image signal processor 312 is illustrated as separate from the processor 304, the image signal processor 312 may be a core of a processor 304 that is an application processor unit (APU), included in a system on chip (SoC), or otherwise included with the processor 304. While the device 300 is referred to in the examples herein for performing aspects of the present disclosure, some device components may not be shown in FIG. 3 to prevent obscuring aspects of the present disclosure. Additionally, other components, number of components, or combinations of components may be included in a suitable device for performing aspects of the present disclosure. As such, the present disclosure is not limited to a specific device or configuration of components, including the device 300.

As noted above, multiple image sensors are coupled to an image signal processor, and the image signal processor processes the frames from the multiple image sensors. Coordinating readout of frames from the multiple image sensors to the image signal processor may be based on triggers provided by the image signal processor (as the master) to the image sensors (as the slaves) to coordinate when the frames are provided by the image sensors to the image signal processor.

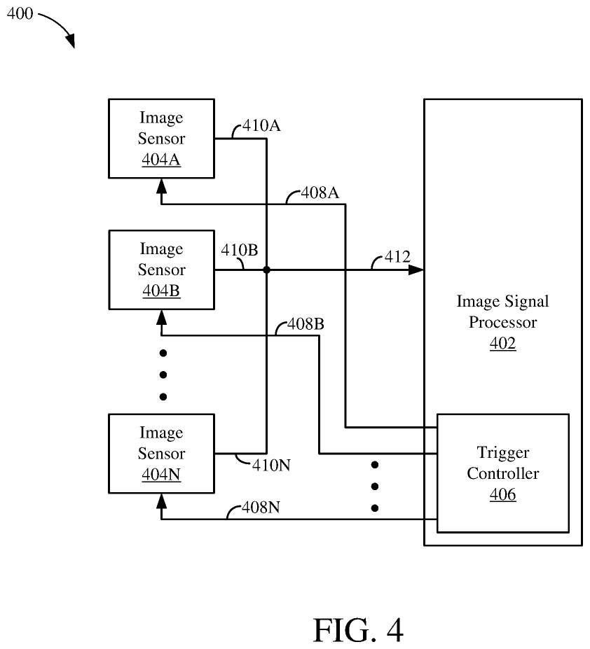

FIG. 4 is a block diagram 400 of an arrangement of multiple image sensors 404A-404N coupled to an image signal processor 402. Each of the image sensors 404A through 404N may be example implementations of the first image sensor 301 and/or the second image sensor 302 in FIG. 3, and the image signal processor 402 may be an example implementations of the image signal processor 312 in FIG. 3. Image sensor 404A includes an output 410A, image sensor 404B includes an output 410B, and so on up to image sensor 404N including an output 410N (for an integer N greater than one) to provide frames to the image signal processor 402 (such as via an input 412 to the image signal processor 402). As shown, coupling the image sensors 404A-404N to the image signal processor 402 does not require coordination circuitry. In some implementations, since the image frames are provided sequentially to the image signal processor 402, the outputs 410A-410N may be connected to the input 412 without a switch or any other components (other than an amplifier, shunt, or other components to prevent the signal from being provided to one of the outputs of an image sensor from another image sensor). Instead, the image signal processor 402 (or another suitable device component) is configured to provide triggers to each of the image sensors 404A-404N to coordinate when frames are to be received from the image sensors. In some implementations, the image signal processor 402 includes a trigger controller 406 coupled to each of the image sensors 404A-404N via connections 408A-408N. In some other implementations, the trigger controller 406 is separate from the image signal processor 402.

The trigger controller 406 is configured to provide a trigger to cause an image sensor to begin capture of a frame (such as a SoE for a frame) or to trigger readout of the frame by the image sensor. In some implementations, a trigger may refer to defined signal value or level. For example, a trigger may include a high signal instance, including an increased voltage, increased current, or other suitable indication or conversely as a low signal instance, including a decreased voltage, decreased current, or other suitable indication for a signal provided by the image signal processor coupled to the image sensor. In this manner, each image sensor coupled to the image signal processor may receive a different signal from the image signal processor. In some other implementations, a trigger may refer to a distinct signal from the image signal processor. For example, a defined signal for an amount of time may be sent by the image signal processor to an image sensor to trigger the image sensor to begin exposure for a frame. Nothing may be transmitted otherwise when the image signal processor is not to trigger the image frame. In this manner, separate signals are sent for each time the image signal processor is to trigger an image sensor to capture or readout an image frame. The examples provided herein describe and illustrate a trigger as a high signal instance of a signal provided by the image signal processor to the image sensor, but any suitable trigger may be used, including a predefined string of bits, a pattern of voltage or current fluctuations, or any other suitable trigger. The present disclosure is not limited to the example triggers described in the examples herein.

The image sensors 404A-404N are slaves to the image signal processor 402. As a result, the image sensors 404A-404N do not readout a frame to the image signal processor 402 until triggered to do so via a trigger provided by the image signal processor 402 (such as via the trigger controller 406). In this manner, the image signal processor 402 may control the triggers being sent to the image sensors 404A-404N to prevent two or more of the image sensors reading out frames to the image signal processor 402 at the same time. Controlling readout may include a trigger being used to indicate a beginning of a frame capture (such as a SoE for a frame). If a frame is not to be captured by an image sensor, no frame readout occurs.

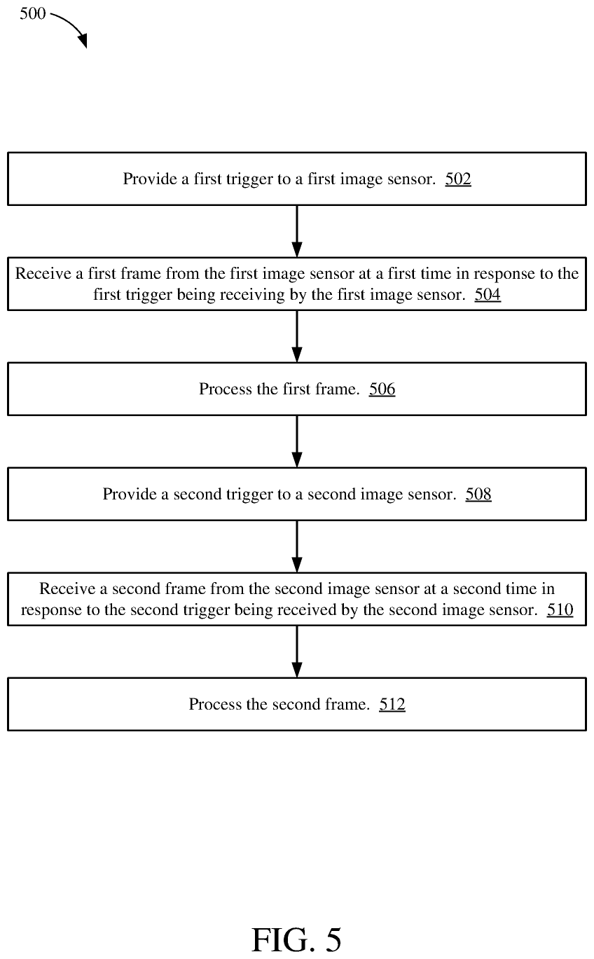

FIG. 5 is an illustrative flow chart depicting an example operation 500 for coordinating processing of image frames from multiple image sensors by a single image signal processor. The operation 500 may be performed by the example device 300 in FIG. 3 or the example image signal processor 402 in FIG. 4. While the example operation 500 is described as being performed by the image signal processor 402 of FIG. 4, any suitable device component (or combination of device components) may perform the operation described.

For the example operation 500, a first trigger to cause a first frame to be received from a first image sensor and a second trigger to cause a second frame to be received from a second image sensor are provided by the image signal processor 402 to the first image sensor and the second image sensor. The triggers are configured (such as sent by the image signal processor 402 at different times or associated with different blanking factors (described below)) so that the first image sensor and the second image sensor are prevented from providing the first image frame and the second image frame to the image signal processor at the same time. In some implementations, a trigger causes an image sensor to begin capture of a frame (such as a SoE for the frame). The frame may be captured and readout to the image signal processor as typically performed by the image sensor. In this manner, the image signal processor 402 may coordinate when the triggers are sent to the image sensors 404A-404N so that frames are received sequentially from the image sensors 404A-404N (without multiple frames arriving concurrently at the image signal processor 402). For example, referring back to FIG. 3, an application processor 304 may provide one or more instructions to the image signal processor 312 that frames are to be captured by the image sensors 301 and 302. The image signal processor 312 thus may send a trigger to the first image sensor 301 and the second image sensor 302 to cause the image sensors to capture an image frame, but the capture of the image frames are timed so that the image frames are not received at the image signal processor 312 at the same time. In some implementations, the image signal processor 312 outputs the triggers at different times for the different image sensors 301 and 302 so that readout of the frames occurs at different times. Scheduling when the triggers are provided to the image sensors 301 and 302 may be based on any known latencies for each image sensor, a time buffer or tolerance to ensure no overlap in receiving the frames, previous measurements of the amount of time to capture and readout a frame, any intentional delays in readout or capture, and so on. In this manner, an amount of time between specific triggers may be known.

Referring back to FIG. 4, in some implementations, the trigger controller 406 may include a counter or timer to measure a defined amount of time to occur between the triggers. In this manner, a first trigger may be sent to the image sensor 404A by the trigger controller 406. Upon sending the first trigger, the trigger controller 406 operates the counter or timer to begin measuring the time up to the defined amount of time between the first trigger and a second trigger. Upon the counter or timer reaching the defined amount of time, the trigger controller 406 provides the second trigger to the image sensor 404B. The defined amount of time may vary depending on the specific image sensors (such as if different image sensors include different configurations or portions to be readout (if not all of the image sensor's information is to be readout, such as for cropping)), an autoexposure operation (which may shorten or lengthen the exposure window for frame capture), a frame rate configured for each image sensor, a resolution for frame capture, and so on. In some implementations, two or more image sensors may be associated with different frame rates based on the triggers provided by the image signal processor to the image sensors. For example, the time between triggers provided by the image signal processor to an image sensor associated with a higher frame rate is less than the time between triggers provided by the image signal processor to an image sensor associated with a lower frame rate.

Alternative or additional to the trigger causing a SoE for frame capture at an image sensor, the trigger may cause an image sensor to readout a current frame to the image signal processor. For example, the image sensor may continuously capture frames, but the frames are not readout to the image signal processor 402 as a result of not receiving a trigger. In this manner, the buffers storing pixel data for the current frame may be cleared so that a next frame may be captured (effectively dumping the current frame). In response to the image sensor receiving a trigger, the image sensor may begin readout of the current frame being captured or that was just captured.

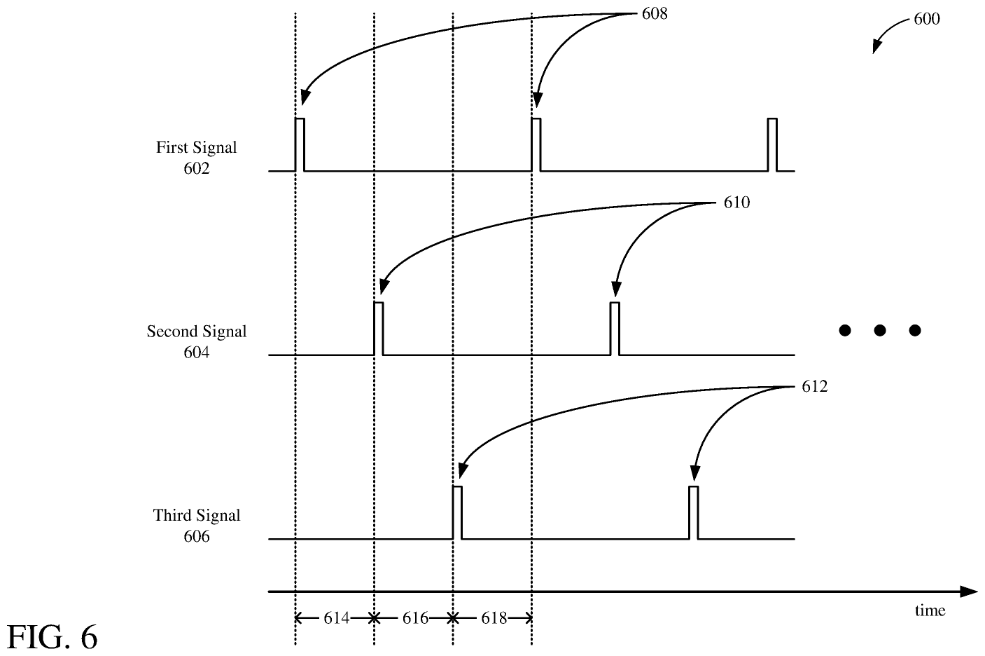

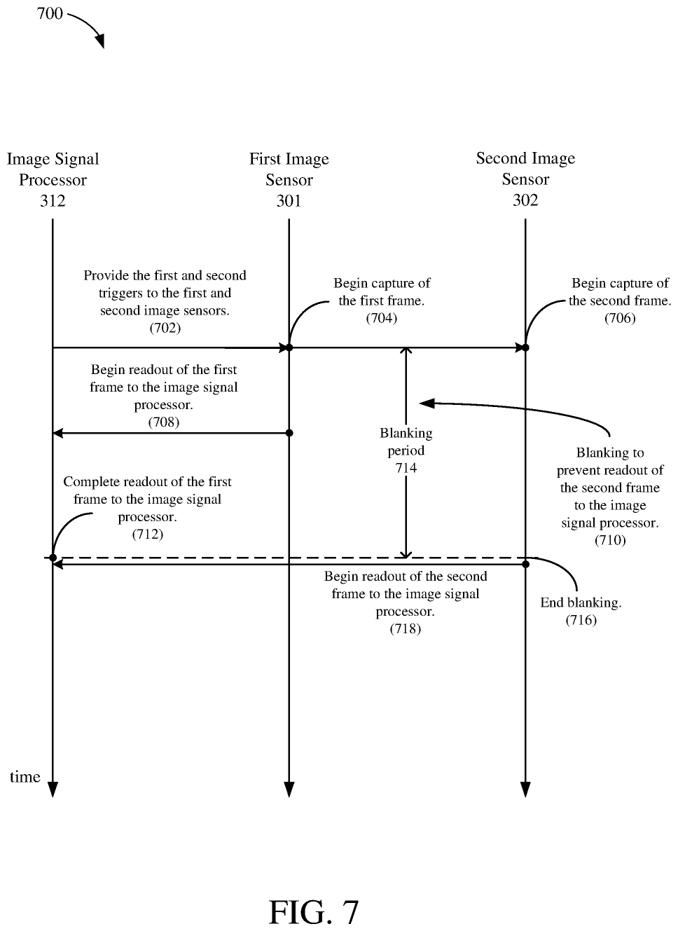

In addition or alternative to the image signal processor 402 coordinating when to send the triggers to the image sensors, one or more image sensors may be associated with a delay in readout of a frame to the image signal processor. The lengths of the delays may be configured to prevent concurrent readout of frames from multiple image sensors, even if triggers are sent to multiple image sensors concurrently. Timing of the triggers provided to the image sensors are described in more detail with reference to FIG. 6 and use of delays (also referred to as blanking factors) are described in more detail with reference to FIG. 7.

Referring back to FIG. 5, with the image signal processor 402 (FIG. 4) determining when to provide the triggers and/or determining one or more blanking factors to delay readout to prevent multiple frames from being received at the same time at the image signal processor 402, the image signal processor 402 provides a first trigger to a first image sensor (502). The first image sensor may capture (such as a SoE) or readout a first frame in response to receiving the first trigger. At 504, the image signal processor receives the first frame from the first image sensor at a first time in response to the first trigger being received by the first image sensor. For example, the first time may be based on when the first trigger is received by the first image sensor. In addition or to the alternative, the first time may be based on a blanking factor associated with the first image sensor. In response to receiving the first frame, the image signal processor 402 processes the first frame (506).

The image signal processor 402 also provides a second trigger to a second image sensor (508). As noted above, in some implementations, the second trigger is provided to the second image sensor at a different time than providing the first trigger to the first image sensor. In some other implementations, the triggers may be provided at the same time (or close to the same time) to the multiple image sensors, and one or more blanking factors associated with the image sensors causes the multiple frames to be provided to the image signal processor 402 one at a time. In some further implementations, the triggers may be sent at different times and the image sensors may be associated with different blanking factors so that the image sensors are controlled to provide the frames to the image signal processor 402 one at a time.

The image signal processor 402 receives the second frame from the second image sensor at a second time in response to the second trigger being received by the second image sensor (510), and the image signal processor 402 processes the second frame in response to receiving the second frame (512). The second time is subsequent to the first time. In this manner, the image signal processor 402 processes the first image frame before processing the second image frame. In addition, the second image frame is received by the image signal processor 402 at a time after the first time so that there is no delay in beginning to process the second image frame. As a result, coordination circuitry or other coordination components are not required at the input to the image signal processor 402 (such as to delay the image signal processor 402 from receiving the second frame before being ready to process the frame). In some implementations, the second time may be based on when the second trigger is provided to the second image sensor. In addition or to the alternative, the second time may be based on a blanking factor associated with the second image sensor. Coordination of the frames may apply to subsequent frames from the first image sensor not being received before being ready to process when processing the second frame or any other previous frames.

While not shown in FIG. 5, the image signal processor may store the processed image frames in a memory for access by another processor (such as the processor 304 in FIG. 3) or device (such as a remote device coupled to the memory). The processer may further process the frames (such as encoding or compressing the frames) for an application or for transmission to another device. In some implementations, the display 314 is used to display one or more of the processed images (such as for a preview or for review by a device user). The user may manipulate the frames based on one or more I/O components 316, including a graphical user interface of the display when displaying the processed first frame and/or the processed second frame.

Referring to coordinating when the triggers are to be provided to the image sensors, FIG. 6 is a timing diagram 600 of triggers 608, 610, and 612 of signals 602, 604, and 606 to three image sensors coupled to a single image signal processor. While three signals are described, any number of signals corresponding to the number of image sensors coupled to the image signal processor may be used. Three signals are illustrated just for clarity in describing aspects of the disclosure. Additionally, while the same amount of time between triggers is illustrated in FIG. 6, any suitable amount of time (which may be static or variable) may be determined and used by the image signal processor. Furthermore, while the triggers are described as causing a SoE for frame capture, the trigger may cause readout of a frame or any other suitable operation for which the frame is provided to the image signal processor.

The first bump 608 (high signal instance) of the first signal 602 is a trigger provided to a first image sensor, and the first image sensor may begin frame capture (such as a SoE). The first bump 610 of the second signal 604 is a trigger provided to a second image sensor, and the second image sensor may begin frame capture (such as a SoE). The image signal processor may determine the time period between the first bump 608 and the first bump 610 to be period 614 to prevent the second frame from the second image sensor being received at the same time as the first frame from the first image sensor. Period 614 may be based on the amount of time for the first image sensor to capture and complete readout of the first frame to the image signal processor. Period 614 may also be based on an amount of time to capture and readout the second frame by the second image sensor. For example, the exposure window before readout at the second image sensor may allow the image signal processor to provide the first bump 610 before the first image sensor completes readout of the first frame (as the readout is completed before the exposure window ends at the second image sensor or readout begins at the second image sensor). In this manner, the image signal processor may reduce the time between frames being received from different image sensors.

Similar processes described above may be performed for determining the period 616 and providing the first bump 612 of the third signal 606 (which prevents receiving a third frame from the third image sensor at the same time as receiving the second frame), determining the period 618 and providing the second bump 608 for the first signal 602 (which prevents receiving another frame from the first image sensor at the same time as receiving the third frame), and so on in timing the triggers to the image sensors. For example, with the first image sensor (which has already been triggered to capture the first frame) to capture another frame, the image signal processor determines when to send another trigger that prevents the new frame from being received from the first image sensor at the same time as another frame is received from another image sensor (such as the second frame from the second image sensor, the third frame from the third image sensor, or another frame from a different image sensor coupled to the image signal processor). The trigger is provided to the first image sensor after the first trigger (previously provided to trigger the first image sensor to provide the first frame) and after the second trigger (previously provided to trigger the second image sensor to provide the second frame). Based on the trigger, the image signal processor receives the new frame from the first image sensor at a time after receiving the first frame and the second frame, and the image signal processor processes the received frame.

Referring back to FIG. 6, the triggers are illustrated as being provided in a round robin manner to the image sensors, but the triggers may be provided in any suitable manner and order. For example, one image sensor may be instructed to capture multiple frames (via multiple triggers) before another image sensor is instructed to capture a frame. Also, as noted above, the triggers are illustrated to have a constant spacing from one another for clarity in describing aspects of the present disclosure, but the spacing may vary and be dynamic as appropriate. The present disclosure is not limited to a specific order of or spacing between the triggers provided to the multiple image sensors. For example, different image sensors may be associated with different frame rates. In this manner, the image signal processor may provide triggers to a first image sensor at a first interval and may provide triggers to a second image sensor at a second interval. The image sensors having different frame rates may correspond to a difference between the first interval and the second interval.

As noted above, in addition or alternative to coordinating when the triggers are provided to the image sensors, one or more image sensors may be associated with a blanking factor to delay readout of a frame after receiving a trigger. Some imaging applications require multiple image sensors to capture corresponding image frames. For example, stereoscopic imaging includes two image sensors capturing frames concurrently. In this manner, the parallax between the image sensors may be used to generate a three dimensional image from the two frames captured by the two image sensors. Since the image sensors may capture frames concurrently, at least a portion of one frame may be readout at the same time a portion of the other frame is readout. To prevent a frame from an image sensor from being provided to the image signal processor at the same time a frame from a different image sensor is provided to the image signal processor, the image sensor may be associated with a blanking factor.

As used herein, a blanking factor may be a value or other indication of how long an image sensor is to delay readout of a frame to the image signal processor. The blanking factor may indicate an amount of time, a multiple of a base unit of time, a number of clock cycles, or any other suitable indication of a period of time. In some implementations, the blanking factor is provided by the image signal processor or another suitable device component, and the blanking factor may be based on a frame rate for image capture, previous readout delays, a tolerance to ensure no overlap, or any other suitable factors that may impact when a frame would be typically provided to an image signal processor. In some other implementations, the blanking factor may be pre-defined (such as during device calibration after production), user-defined, or stored for the image sensor. In some implementations, each image sensor may be associated with its own unique value or amount of time. The blanking factor may indicate a time to delay readout beginning from when the trigger is received. In some other implementations, the blanking factor may indicate a time to delay readout beginning from the end of an exposure window or other suitable starting point. While some examples of a blanking factor are provided, any suitable implementation of a blanking factor may be used, and the present disclosure is not limited to a specific example of a blanking factor. With one or more image sensors being associated with a unique blanking factor, multiple image sensors may capture frames concurrently, but the frames are readout at different times for the different image sensors so that the image signal processor sequentially receives the frames from the image sensors.

FIG. 7 is a timing diagram 700 of frame readouts from multiple image sensors 301 and 302 to a single image signal processor 312 based on blanking. While the timing diagram 700 is described with reference to the device 300 in FIG. 3, any suitable device or device components may perform the described operations for the timing diagram 700. At time 702, the image signal processor 312 provides the first trigger and the second trigger to the first image sensor 301 and the second image sensor 302, respectively. While the timing diagram illustrates the triggers being provided at the same time to the image sensors 301 and 302, the triggers may be provided at different times or any suitable times.

Upon receiving the first trigger, the first image sensor 301 may begin capture of a first frame (704). Upon receiving the second trigger, the second image sensor 302 may begin capture of the second frame (706). In some implementations, capture of the first frame and capture of the second frame may be at the same time (or close to the same time). For example, providing the first and second triggers at the same time (or close to the same time) may cause the first frame and the second frame to be captured at the same time (or close to the same time).

At 708, the first image sensor 301 begins readout of the first frame to the image signal processor 312. For example, if the first image sensor 301 includes a rolling shutter, one or more lines of the first frame may be readout to the image signal processor, and additional lines are readout after readout of the first one or more lines. In another example, if the first image sensor 301 includes a global shutter, the exposure window ends for all pixels of the image sensor, and the frame is readout to the image signal processor 312 after the exposure window ends. If the second image sensor 302 is similar to the first image sensor 301, the second image sensor 302 may also be ready to begin readout at or near 708. To prevent the second image sensor 302 from reading out the second frame when the first frame is being readout to the image signal processor 312, the second image sensor performs blanking (710). For example, a blanking factor is used to delay a column buffer and row buffer (used to collects pixel data from the image sensor pixels) from collecting pixel data for a period of time or from providing the collected pixel data to the image signal processor for a period of time. The blanking period 714 (during which the second image sensor 302 prevents readout of the second frame to the image signal processor 312) is based on when the first frame is readout to the image signal processor 708. For example, the blanking period 714 may be a defined amount of time based on the blanking factor that is universally long enough to prevent the second frame from being provided to the image signal processor 312 at the same time the first frame is provided to the image signal processor 312. In another example, the blanking period 714 is a variable amount of time based on the blanking factor (which varies based on a frame readout of the first frame, frame rate, or other factors that may impact when the second frame is ready for readout and when the first frame is completely readout to the image signal processor). In some implementations, the blanking factor may be provided with the trigger or may be provided in a separate control signal (such as from the processor 304 or the image signal processor 312) to the image sensor, and the image sensor determines the blanking period based on the blanking factor. For example, the image signal processor 312 may provide an indication of a blanking factor (such as a number, flag, or value that may be used by the image sensor to determine the blanking period), and the image sensor applies the blanking factor (performs the blanking) to delay readout of a frame based on the indication of the blanking factor.

At 712, the first image sensor 301 completes readout of the first frame to the image signal processor 312. As illustrated, the blanking period 714 may end at or near the time when readout of the first frame is completed (716). While blanking is illustrated as being for the blanking period 714 from when the second image sensor 302 receives the second trigger to when the first image sensor 301 completes readout of the first frame, blanking may begin and end at any suitable times.

With the blanking period 714 ending, the second image sensor 302 begins to readout the second frame to the image signal processor 312 (718). While a space is illustrated between when the blanking period 714 ends and when the second frame begins to be readout (718) in the example in FIG. 7, readout of the second frame may begin immediately without any separation in time. The operations described with reference to the timing diagram 700 in FIG. 7 may be expanded to any number of image sensors coupled to and any number of frames to be provided to a single image signal processor. As such, the example timing diagram 700 is limited to two image sensors exclusively for clarity in explaining aspects of the present disclosure. The present disclosure is not limited to a specific number of image sensors, a specific number of blanking factors or blanking periods, or to specific examples of when blanking occurs to prevent multiple frames from being received at the image signal processor at the same time.

In some implementations, an error may occur where an image signal processor receives at least part of a first frame concurrently with at least part of a second frame. For example, the timing of the triggers may be incorrect or an incorrect blanking factor may have been used. If conflicting frames are received or cause interference in receiving image frames at the image signal processor, the image signal processor may disregard the data received for those frames and perform example operation 500 (FIG. 5) again. In performing such operation, the image signal processor may determine when to send the triggers or adjust the blanking factors for one or more image sensors. In this manner, the image signal processor is able to overcome any errors in receiving frames in their entirety and in a sequential manner.

Since the image signal processor is the master to the image sensors coupled to the image signal processor, the described operations above may also be used in reducing device power consumption. For example, when a device typically executes an imaging application, all of the image sensors are enabled and all of the image sensors capture image frames and readout each image frame. The imaging application may only require frames from one image sensor or from a subset of all of the image sensors of the device. Conventionally, a device may disable one or more of the image sensors as not needed (such as placing the image sensors in a low power state). If the device needs the image sensor to begin capturing images, the device removes the image sensor from the low power state, initializes the image sensor (such as by performing autofocus (AF), autoexposure (AE), and automatic white balance (AWB) operations), and configures the initialized image sensor to begin capturing image frames. Initialization and configuration requires an amount of time that delays when the image sensor is ready to be used, and the delay may be noticeable to the user (such as half a second or more).

Frame readout consumes a large portion of the power required to keep the image sensor enabled. If frame readout can be prevented, power consumption is reduced without placing the image sensor into a low power state. With the image sensors as slaves to the image signal processor, the image sensors are prevented from performing frame readout until receiving a trigger from the image signal processor. In this manner, power consumption of the image sensors may be reduced by preventing triggers from being provided to one or more image sensors when not needed. Since the image sensors are not placed into a low power state, an image sensor does not need to be initialized or configured to capture an image frame. As a result, a trigger can be provided to the image sensor when appropriate, and the image sensor captures one or more image frames without a delay typically required in removing an image sensor from a low power state.

In addition or alternative to reducing power consumption while not placing one or more image sensors into a low power state, the described operations above may be used for improving reconfiguration operations of an image sensor. An image sensor may be reconfigured, such as changing one or more configurations of the image sensor based on changing the frame rate, changing the resolution (such as changing the remosaicing), or changing other aspects of the frames from the image sensor. Conventionally, an image sensor (such as the first image sensor 301) to be reconfigured is active, with the image sensor performing readouts of frames being captured. Referring to FIG. 3, the processor 304 may provide instructions to the image signal processor 312 to reconfigure the first image sensor 301. The image signal processor 312 converts the received instructions to specific instructions for the first image sensor 301. The image signal processor 312 then instructs the first image sensor 301 to reconfigure by providing the specific instructions. The first image sensor 301 is deactivated (such as removing power from one or more components or placing the image sensor on standby to prevent further frame captures and readouts), is reconfigured, and then is reactivated (which may include reapplying power to one or more components of the image sensor, reinitializing and reconfiguring the image sensor, including performing AF, AE, and AWB operations, and other operations which may take half a second or more before the image sensor is ready). Deactivating and reactivating the image sensor thus increases the amount of time required to reconfigure the image sensor.

In the present disclosure, since the image sensors are slaves to the image signal processor, the image sensors do not readout frames to the image signal processor without a trigger. In some implementations, the image sensors do not capture a frame without receiving a trigger. In this manner, an image sensor is not required to be deactivated before reconfiguring the image sensor. Instead, the image signal processor prevents sending a trigger to the image sensor while the image sensor is being reconfigured. In this manner, the image sensor may be reconfigured without requiring deactivation and reactivation, thus reducing the amount of time required to reconfigure the image sensor.

Reconfiguring an image sensor without requiring deactivation or powering down at least a portion of the image sensor may be particularly beneficial for video capture and generation. Conventional reconfiguration of an image sensor (requiring powering down or otherwise deactivating the image sensor) may cause a pause or blank space in a video (during which no frames are being captured by the image sensor) of half a second or more. Reconfiguring the image sensor without powering down (such as based on preventing sending triggers to the image sensor during reconfiguration) reduces the length of the pause or blank space in the video attributed to reconfiguring the image sensor.

The above implementations and techniques may apply to different types of image sensors and configurations. For example, in addition to being applicable to image sensors that capture or readout frames at 30 frames per second (fps), 60 fps, or other typical frame rates for image or video capture, the techniques may also be applicable to image sensors configured in a fast shutter or fast readout mode. In some implementations, one or more of the image sensors are configured to capture or readout 120 fps (or more).

In one example, an image signal processor is coupled to four image sensors. For example, referring back to FIG. 4, image signal processor 402 is coupled to a first image sensor 404A, a second image sensor 404B, a third image sensor 404C, and a fourth image sensor 404D (where N equals D in the example). Each of the image sensors 404A-404D are configured to capture 120 fps. At 120 fps, an image sensor provides a frame to the image signal processor 402 approximately every 8 milliseconds (ms). In some implementations, the image signal processor 402 may be configured to control readout of frames to the image signal processor 402 so that each image sensor appears to provide frames at a rate of 30 fps even though its capture rate is 120 fps.

An image sensor capturing 30 fps corresponds to a frame being captured approximately every 32 ms. The image signal processor 402 may be configured to trigger each of the image sensors 404A-404D to be active during 8 ms of each 32 ms period. Otherwise, the image sensor may be blanked for the other 24 ms of the 32 ms period. In this manner, a different image sensor is active each 8 ms subperiod of the 32 ms period. As used herein, an image sensor being active may refer to the image sensor performing readout of a frame captured during the 8 ms, and an image sensor being blanked may refer to the image sensor being prevented from performing readout of frames captured during the 24 ms. In this manner, each image sensor may continue to capture four frames per 32 ms period, but only one frame is readout to the image signal processor 402. In some other implementations, the image sensor being active may refer to the image sensor capturing one or more image frames, and the image sensor being blanked may refer to the image sensor not capturing image frames.

With the image sensors 404A-404D to be active during an 8 ms subperiod each 32 ms period, the image signal processor 402 may time when to send the triggers and/or configure a blanking factor for one or more image sensors to coordinate when each image sensor is to be active (and when to be blanked). While the above example describes four image sensors configured for fast readout (thus able to capture and readout frames at 120 fps) to each effectively provide 30 fps, any suitable number of image sensors, effective frame rates, fast readout rates, or other suitable configurations for when an image sensor is to be active or is to be blanked may be used. The above example is provided for clarity in describing techniques of the present disclosure as applicable to fast readout image sensors, and is not to limit the scope of the present disclosure.

Various techniques for an image signal processor to coordinate the reception of frames from multiple image sensors is described herein. As noted, the image signal processor does not require coordination circuitry preceding the image sensor and receiving frames from the image sensors. As described above, based on the image sensors being slaves to the image signal processor, different operations and aspects of image capture and processing may be improved. The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 306 in the example device 300 of FIG. 3, and also referred to as a non-transitory computer-readable medium) comprising instructions 308 that, when executed by the image signal processor 312, the processor 304, or another suitable component, cause the device 300 to perform one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits, and instructions described in connection with the embodiments disclosed herein may be executed by one or more processors, such as the processor 304 or the image signal processor 312 in the example device 300 of FIG. 3. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

As noted above, while the present disclosure shows illustrative aspects, it should be noted that various changes and modifications could be made herein without departing from the scope of the appended claims. For example, while one trigger is described as being used to indicate a frame is to be captured or readout, any suitable number of triggers may be used. In a specific example, a first trigger may cause frame capture to begin and a second trigger may cause readout of the captured frame. In another example, one trigger may be used to cause an image sensor to capture and readout a plurality of frames. As such, any suitable triggers and blanking factors may be used in coordinating the reception of multiple frames by the image signal processor.

Additionally, the functions, steps or actions of the method claims in accordance with aspects described herein need not be performed in any particular order unless expressly stated otherwise. For example, blocks 504 and 510 in FIG. 5 may be performed sequentially in any order or concurrently, blocks 506 and 512 may be performed in any suitable order, and blocks 508 and 514 may be performed in the order the frames are received. Furthermore, although elements may be described or claimed in the singular, the plural is contemplated unless limitation to the singular is explicitly stated. For example, while two image sensors capturing two image frames or three image sensors capturing three image frames are described in the examples, any number of image sensors may be used to capture any number of image frames. Accordingly, the disclosure is not limited to the illustrated examples, and any means for performing the functionality described herein are included in aspects of the disclosure.

What is claimed is:

1. A device for digital image processing, comprising:
an image signal processor configured to:
provide a first trigger to a first image sensor, the first image sensor being coupled to the image signal processor;
receive a first frame from the first image sensor at a first time in response to the first trigger being received by the first image sensor;
process the first frame;
provide a second trigger to a second image sensor, the second image sensor being coupled to the image signal processor;
receive a second frame from the second image sensor at a second time in response to the second trigger being received by the second image sensor,
wherein the second time is subsequent to the first time; and
process the second frame; and
a memory coupled to the image signal processor, wherein the memory is configured to store the processed first frame and the processed second frame received from the image signal processor.

2. The device of claim 1, wherein:
capture of the first frame by the first image sensor is based on when the first image sensor receives the first trigger; and
capture of the second frame by the second image sensor is based on when the second image sensor receives the second trigger.

3. The device of claim 2, wherein the image signal processor is further configured to determine when to provide the second trigger to the second image sensor based on an imaging parameter associated with the first frame, wherein:
the first image sensor begins capture of the first frame upon receiving the first trigger; and
the second image sensor begins capture of the second frame upon receiving the second trigger.

4. The device of claim 3, wherein the imaging parameter includes one or more of:
an exposure window size for the first frame; or
a size of the first image sensor for readout for the first frame.

5. The device of claim 1, wherein the second trigger is associated with a blanking factor to delay readout of the second frame by the second image sensor to the image signal processor.

6. The device of claim 5, wherein:
the first frame and the second frame are captured concurrently; and
the second frame is prevented from being received at the same time as the first frame at the image signal processor based on the delayed readout of the second frame by the second image sensor.

7. The device of claim 5, wherein the image signal processor is further configured to provide an indication of the blanking factor to the second image sensor, wherein the second image sensor applies the blanking factor to delay readout based on the indication.

8. The device of claim 1, wherein:
the image signal processor is further configured to:
provide a third trigger to the first image sensor;
receive a third frame from the first image sensor at a third time in response to the third trigger being received by the first image sensor, wherein the third time is subsequent to the first time and different than the second time; and
process the third frame; and
the memory is further configured to store the processed third frame received from the image signal processor.

9. The device of claim 8, wherein:
the image signal processor is further configured to:
provide a fourth trigger to the second image sensor, wherein:
a timing between the first trigger and the third trigger is associated with a first frame rate of the first image sensor; and
a timing between the second trigger and the fourth trigger is associated with a second frame rate of the second image sensor different from the first frame rate;
receive a fourth frame from the second image sensor at a fourth time in response to the fourth trigger being received by the second image sensor,
wherein the fourth time is subsequent to the second time and the fourth time; and
process the fourth frame;
the memory is further configured to store the processed fourth frame received from the image signal processor.

10. The device of claim 1, further comprising:
one or more processors coupled to the memory, wherein the one or more processors are configured to obtain the processed first frame and the processed second frame from memory.

11. The device of claim 10, further comprising:
the first image sensor to capture the first frame; and
the second image sensor to capture the second frame.

12. The device of claim 11, further comprising a display configured to display the processed first frame and the processed second frame.

13. A method for digital image processing, comprising:
providing, by an image signal processor, a first trigger to a first image sensor, the first image sensor being coupled to the image signal processor;
receiving, by the image signal processor, the first frame from the first image sensor at a first time in response to the first trigger being received by the first image sensor;
processing the first frame;
providing, by the image signal processor, a second trigger to a second image sensor, the second image sensor being coupled to the image signal processor;
receiving, by the image signal processor, the second frame from the second image sensor at a second time in response to the second trigger being received by the second image sensor, wherein the second time is subsequent to the first time; and
processing the second frame.

14. The method of claim 13, wherein:
capture of the first frame by the first image sensor is based on when the first image sensor receives the first trigger; and
capture of the second frame by the second image sensor is based on when the second image sensor receives the second trigger.

15. The method of claim 14, further comprising determining when to provide the second trigger to the second image sensor based on an imaging parameter associated with the first frame, wherein:
the first image sensor begins capture of the first frame upon receiving the first trigger; and
the second image sensor begins capture of the second frame upon receiving the second trigger.

16. The method of claim 15, wherein the imaging parameter includes one or more of:
an exposure window size for the first frame; or
a size of the first image sensor for readout for the first frame.

17. The method of claim 13, wherein the second trigger is associated with a blanking factor to delay readout of the second frame by the second image sensor to the image signal processor.

18. The method of claim 17, wherein:
the first frame and the second frame are captured concurrently; and
the second frame is prevented from being received at the same time as the first frame at the image signal processor based on the delayed readout of the second frame by the second image sensor.

19. The method of claim 17, further comprising:
providing, by the image signal processor, an indication of the blanking factor to the second image sensor, wherein the second image sensor applies the blanking factor to delay readout based on the indication.

20. The method of claim 13, further comprising:
providing, by the image signal processor, the third trigger to the first image sensor;
receiving, by the image signal processor, a third frame from the first image sensor at a third time in response to the third trigger being received by the first image sensor, wherein the third time is subsequent to the first time and different than the second time; and
processing the third frame.

21. The method of claim 20, further comprising:
providing, by the image signal processor, a fourth trigger to the second image sensor, wherein:
a timing between the first trigger and the third trigger is associated with a first frame rate of the first image sensor; and
a timing between the second trigger and the fourth trigger is associated with a second frame rate of the second image sensor different from the first frame rate;
receiving, by the image signal processor, a fourth frame from the second image sensor at a fourth time in response to the fourth trigger being received by the second image sensor, wherein the fourth time is subsequent to the second time and the fourth time; and
processing the fourth frame.

22. A non-transitory, computer readable medium storing instructions, that when executed by one or more processors of a device, cause the device to:
provide, by an image signal processor, a first trigger to a first image sensor, the first image sensor being coupled to the image signal processor;
receive, by the image signal processor, the first frame from the first image sensor at a first time in response to the first trigger being received by the first image sensor;
process the first frame;
provide, by the image signal processor, a second trigger to a second image sensor, the second image sensor being coupled to the image signal processor;
receive, by the image signal processor, the second frame from the second image sensor at a second time in response to the second trigger being received by the second image sensor, wherein the second time is subsequent to the first time; and
process the second frame.

23. The computer readable medium of claim 22, wherein:
capture of the first frame by the first image sensor is based on when the first image sensor receives the first trigger; and
capture of the second frame by the second image sensor is based on when the second image sensor receives the second trigger.

24. The computer readable medium of claim 22, wherein execution of the instructions further causes the device to determine when to provide the second trigger to the second image sensor based on an imaging parameter associated with the first frame, wherein:
the first image sensor begins capture of the first frame upon receiving the first trigger; and
the second image sensor begins capture of the second frame upon receiving the second trigger.

25. The computer readable medium of claim 24, wherein the imaging parameter includes one or more of:
an exposure window size for the first frame; or
a size of the first image sensor for readout for the first frame.

26. The computer readable medium of claim 22, wherein the second trigger is associated with a blanking factor to delay readout of the second frame by the second image sensor to the image signal processor.

27. The computer readable medium of claim 26, wherein:
the first frame and the second frame are captured concurrently; and
the second frame is prevented from being received at the same time as the first frame at the image signal processor based on the delayed readout of the second frame by the second image sensor.

28. The computer readable medium of claim 26, wherein execution of the instructions further causes the device to:
provide, by the image signal processor, an indication of the blanking factor to the second image sensor, wherein the second image sensor applies the blanking factor to delay readout based on the indication.

29. The computer readable medium of claim 22, wherein execution of the instructions further causes the device to:
provide, by the image signal processor, a third trigger to the first image sensor;
receive, by the image signal processor, a third frame from the first image sensor at a third time in response to the third trigger being received by the first image sensor, wherein the third time is subsequent to the first time and different than the second time; and
process the third frame.

30. The computer readable medium of claim 29, wherein execution of the instructions further causes the device to:
provide, by the image signal processor, a fourth trigger to the second image sensor, wherein:
a timing between the first trigger and the third trigger is associated with a first frame rate of the first image sensor; and
a timing between the second trigger and the fourth trigger is associated with a second frame rate of the second image sensor different from the first frame rate;
receive, by the image signal processor, a fourth frame from the second image sensor at a fourth time in response to the fourth trigger being received by the second image sensor, wherein the fourth time is subsequent to the second time and the fourth time; and
process the fourth frame.
